(19) United States
(12) Patent Application Publication
(10) Pub. No.: US 2007/0189659 A1
(43) Pub. Date: Aug. 16, 2007

(54) Thin Film Optical Patterning Devices

(76) Inventor: Jeng-Jye Shau, Palo Alto, CA (US)

Correspondence Address: Jeng-Jye Shau, 991 Amarillo Ave., Palo Alto, CA, 94303, US

(21) Appl. No.: 11/307,529

(22) Filed: Feb. 10, 2006

Related U.S. Application Data
(63) Continuation-in-part of application No. 11/307,253, filed on Jan. 29, 2006, now abandoned.

(51) Int. Cl. G02B 6/10

(52) U.S. Cl. 385/14; 385/130

(57) ABSTRACT

The present invention provides structures and methods for manufacturing thin film optical devices that perform the functions of prior art focal lenses. Multiple light beams are guided to the same focal point through thin film optical fiber channels with IC grade precision. The optical fiber lens of the present invention provides significant improvement for applications such as compact disk drivers, scanners, copy machines, and surgery knifes.

This is a continue-in-part application of U.S. application Ser. No. 11/307,253 filed Jan. 29, 2006.

### BACKGROUND OF THE INVENTION

The present invention relates to optical devices for focusing on small optical objects and more particularly to precision thin film optical focusing devices manufactured by integrated circuit technologies.

Integrated circuit (IC) technologies have been advancing at an amazing pace. Current art IC thin film technologies are capable of growing thin films with thickness variation controlled at the level of single atoms; IC lithography technologies are able to control critical dimensions with nanometer (nm, 10⁻⁹ meters) resolution; billions of thin film transistors are manufactured on the same wafer with nearly identical properties. It is a terrible waste if the knowledge accumulated by the IC industry is only used to build integrated circuits. It is therefore strongly desirable to use IC technologies for other applications.

The optical fiber industry has been taking advantage of IC technologies in building optical components such as optical multiplexers, which are illustrated in FIG. 1. This device comprises of traces of optical fiber channels (101, 102, 103) that are patterned by IC lithographic technology. These optical fiber channels (101, 102, 103) have a higher index of refraction than that of nearby materials. Also shown in FIG. 1 are the cross-section views of the optical fiber channels (102, 103) at the location marked by dashed lines. A protective thin film (104) is deposited on top of the substrate (100). The optical fiber channels (102, 103) are the small areas embedded in the protection thin film (104). Single crystal Silicon is the most common material used as the substrate (100), but other materials can be used too. Most protective thin films (104) are made of SᵢO₂. The most common material for the optical fiber channels (101, 102, 103) is doped SᵢO₂ that has a higher index of refraction than the protective thin film (104). These materials are all commonly used by the IC industry with excellent control in pattern and composition. It is therefore possible to define the properties of thin film optical devices with IC grade accuracy.

The “optical fiber channels” described above are not optical fibers. They are actually a channel of thin film materials that have a higher index of refraction than the surrounding materials. We call them “optical fiber channels” because they provide the same function as optical fibers. Due to total reflection, a light beam can travel along the optical fiber channels (101, 102, 103) with nearly no loss. IC patterning technologies provide high resolution in patterning while IC thin film manufacture technologies allow excellent uniformity/composition controls. Therefore, we will be able to control light with IC grade precision. For the example shown in FIG. 1, a single channel (B₁) on the right hand side is divided evenly into 8 symmetrical channels (A₁-A₈). A light beam coming in from B₁ would be divided into 8 light beams (A₁-A₈), allowing the structure to perform the function of a multiplexer. Similarly, 8 light beams (A₁-A₈) come from left side would be merged to into a single output B₁, allowing the structure to perform the function of a de-multiplexer. We need IC manufacture technologies to make sure that all 8 channels have matching properties so that the light beams are multiplexed evenly. Besides multiplexers and de-multiplexers, other types of optical devices have been manufactured using similar principles.

For many applications, it is desirable to concentrate light beams into small focal points with high accuracy in order to form or detect optical patterns. Conventional light focusing methods using optical lenses are limited by the resolution of mechanical technologies. It is desirable to achieve IC grade precision by applying IC technologies to build light focusing optical devices.

### SUMMARY OF THE INVENTION

The primary objective of the present invention is therefore to provide precision optical devices for focusing and/or detecting light at small focal points. Another objective of this invention is to improve the storage capacity and/or the performance of compact disks (CD). Another objective is to improve cost efficiency and precision of pattern detecting/writing applications such as scanners, copy machines, printers, and optical mice (computer cursor control devices). The other objective of this invention is to provide precision cutting devices.

These and other objectives are achieved by thin film optical devices comprising of precision optical fiber channels. At least two of the optical fiber channels are pointed with IC grade precision to the same focal point outside of the thin film device. In many ways, the optical device of the present invention uses optical fiber wave guides to support the functions of prior art lens. These optical fiber devices support applications that require the capability to focus or detect light at one or more focal points with accuracy.

While the novel features of the invention are set forth with particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 illustrates the structure of a prior art optical thin film device;

FIGS. 2(a-f) are cross-section diagrams showing prior art manufacture procedures for optical thin film devices;

FIGS. 2(g-j) are cross-section diagrams of example modified manufacture procedures of the present invention;

FIGS. 3(a,b) illustrate the structures of a prior art compact disk optical reader;

FIGS. 4(a-i) illustrate the structures of example CD optical readers of the present invention;

FIGS. 5(a-i) show application examples of the present invention as a precision optical knife;

FIGS. 6(a,b) illustrate the effects of interference; and

FIGS. 7(a-f) show three dimensional devices of the present invention.

### DETAILED DESCRIPTION OF THE INVENTION

In the following discussions, we assume the readers are familiar with the art of thin film optical devices with fundamental knowledge in IC manufacture technologies and in optical fiber designs. Details such as manufacturing recipes and composition of materials for well-known IC manufacture procedures will not be provided to keep our discussions concise. We often use the terminology “IC grade precision”. That means the achieved resolution or precision is equivalent to the precision commonly achievable by IC manufacture technologies. For example, if we use the equipment of 0.13 micrometer IC technology, we should be able to define minimum dimensions around 130 nm; if we use newer 65 nm IC technology, we should be able to define minimum dimension around 65 nm; if we use older 1.2 micrometer IC technology, we should be able to define minimum dimension around 1.2 micrometers. Optical thin film devices sometimes use a combination of different generations of IC technologies.

IC technologies can define dimensions with a resolution smaller than the wavelength of visible light. The effects of interference are very important when the dimension is so small. Optical designs need to consider three-dimensional interference of light beams, requiring complex mathematical analysis and compensation methods. To avoid using complex equations, we will assume the readers already know prior art optical designs in detail and simplify our discussions and illustrations using geometric optics without detailed discussions on the effect of interference. In this way, we can use simplified models to illustrate the key points and the applications of the present invention. Usage of simplified models should not limit the scope of the present invention.

Dimensions of the structures in our figures are often not drawn to scale for better clarity.

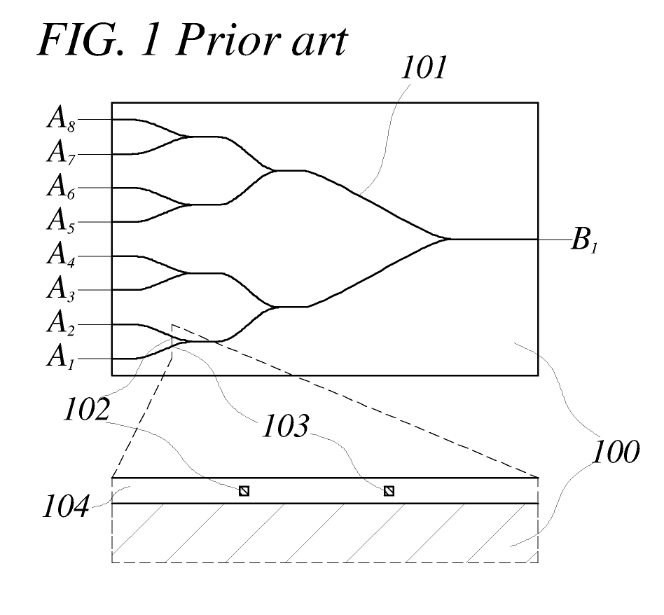

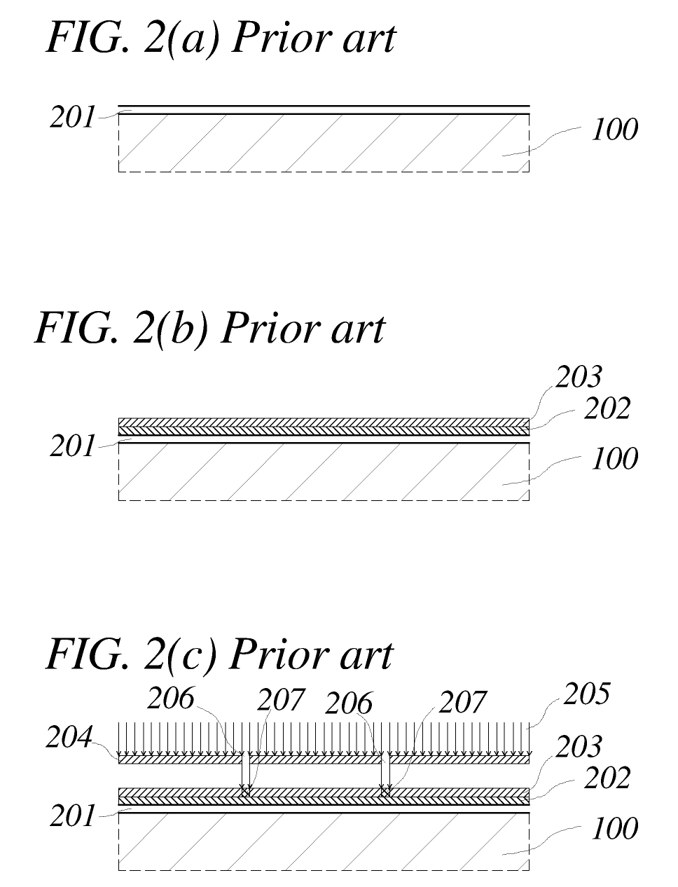

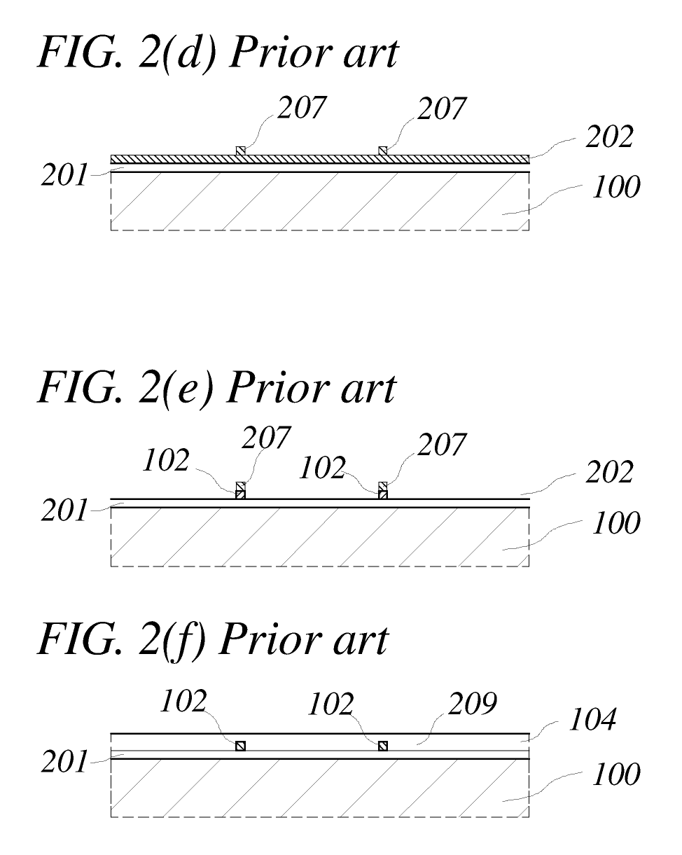

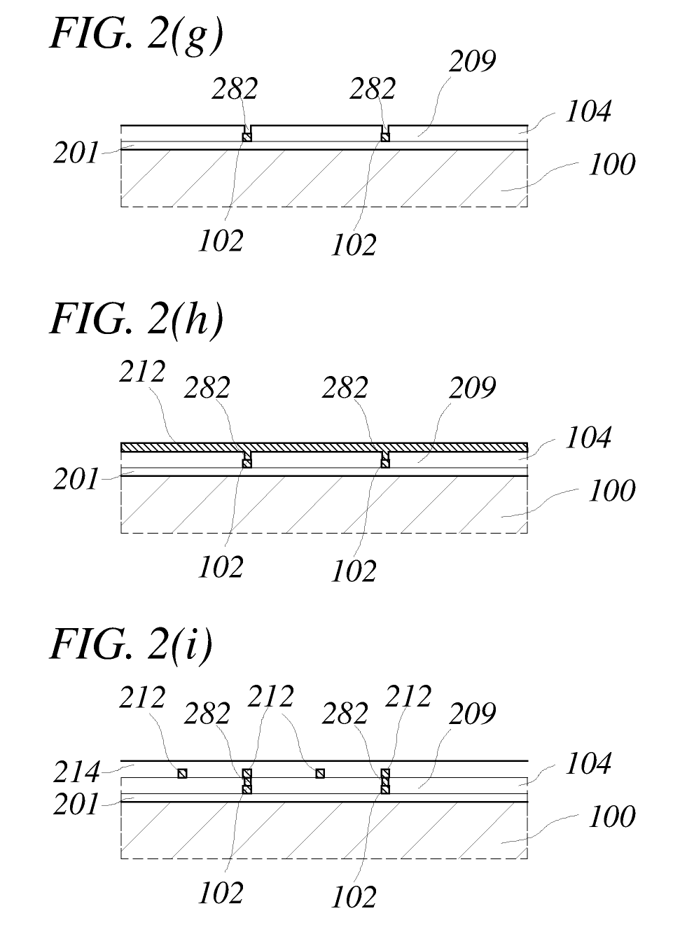

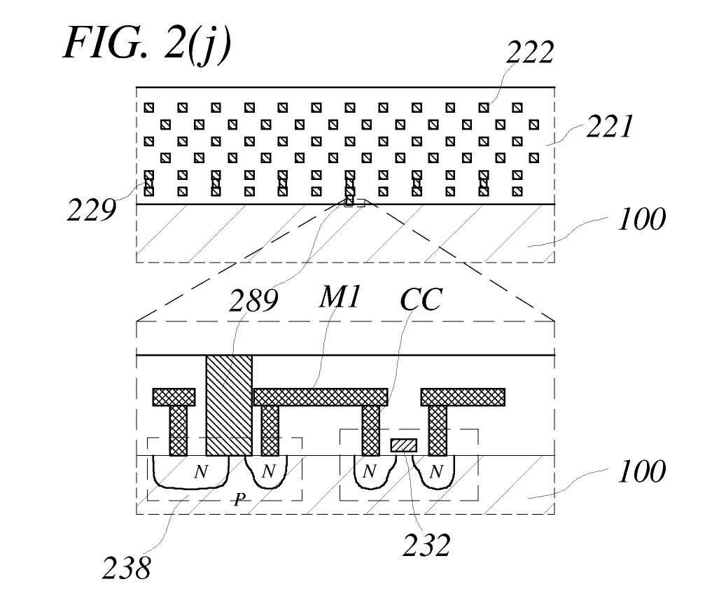

FIGS. 2(a-j) are cross-section diagrams illustrating example manufacture procedures for optical thin film devices using IC manufacture technologies. FIG. 2(a) shows the cross-section views when a protective thin film (201) is grown or deposited on top of a substrate (100). Single crystal silicon is the most common material used for the substrate (100). The substrate also can be other types of materials. The most common material for the protective thin film (104) is SᵢO₂; for many applications we may want to choose other types of materials such as plastic thin film. FIG. 2(b) shows the cross-section views when a different thin film (202) with a different (typically higher) index of refraction and a layer of photoresist (203) is deposited on top of the protective thin film (104). The next step is to use a lithography mask (204) to define the pattern of the doped thin film (202). Light beams (205) pass through transparent areas (206) on the mask (204) to patterned areas (207) on the photoresist (203) according to the pattern defined by the mask (204), as illustrated in FIG. 2(c). Chemical procedures etch away the photoresist (203) except at the patterned areas (207) in similar ways as camera film development, as shown in FIG. 2(d). Those processes etch away the exposed doped thin film (202) except in the areas (102) underneath the patterned photoresist (207) as illustrated in FIG. 2(e). Another protective thin film (209) that typically has the same composition as the first protective thin film (201) is deposited on top to form a protective thin film (104) surrounding the optical fiber channels (102) as illustrated in FIG. 2(f). The cross-section views shown in FIG. 2(f) are similar to the cross-section views shown in FIG. 1. Prior art optical thin film procedures typically stop here with a single layer of optical fiber channels (102).

IC technologies allow us to have multiple layers of optical fiber channels as illustrated in FIGS. 2(g-j). Using similar IC manufacture procedures for via holes, we can etch via holes (282) in the protective thin film (209) as illustrated in FIG. 2(g) and deposit the second layer of doped thin film (212) that has a higher index of refraction as illustrated in FIG. 2(h). Repeating the procedures in FIGS. 2(b-f), we can have a second layer of optical fiber channel (212) as illustrated in FIG. 2(i). These second layer optical fiber channels (212) are also covered by protective thin film (214). In addition, the second layer optical fiber channels (212) can communicate with the first layer optical fiber channels (102) through optical via (282) filled with the same materials as the second layer optical fiber channels (212). Repeating similar procedures, we can have multiple layers of optical fiber channels (222) as illustrated in FIG. 2(j). Different layers of optical fiber channels (222) can be connected with optical via (229). Such optical via (229) can be generated in ways similar to those used for IC technologies or by an ion implant process. The via generated by IC technologies typically is limited in size. It is desired to have flexibility in shapes for optical via holes.

If the substrate (100) is semiconductor, it would be a waste to use the substrate only for mechanical support. We have the flexibility to build active integrated circuits on the substrate before forming the optical fiber channels as illustrated in the magnified cross-section diagram in FIG. 2(j). In this example, the substrate has circuit elements such as an open-base bipolar transistor (238) that can be used as optical detector, and an MOS transistor (232) with contacts (CC) and metal connections (M1). In this example, an optical via (289) connects an optical fiber channel directly to the base of the bipolar transistor (238) as illustrated in FIG. 2(j). In this way, we can place light detectors and control circuits directly on the same substrate (100) used by the thin film optical devices. Similarly, we also can place other types of circuits such as light sources (not shown) on the same substrate (100). We may need to be careful with high temperature heat treatments during formation of optical components when embedded circuits are on the same substrate. In the above examples we did not show use of other features such as metal reflector layers (vertically and/or horizontally patterned) or anti-reflection layers (typically are areas with controlled index of reflection) because those manufacture procedures are well known to those with ordinary skill in the art. Those detailed structures will be used in the following application examples but not shown in FIGS. 2(a-j) for simplification and clarity in figures. Sometimes, we also can use reflection materials (such as metal) in part or in all of the “optical fiber channels” of the present invention to guide light beams, especially when we need sharp turning angles.

Since the pattern and the composition of these optical fiber channels are defined by IC manufacture technologies, they have IC grade precision in both uniformity and spatial resolution. It is also well known that we can use the dimension of those optical fiber channels to control the properties of light beams confined by them. For example, we can control the light to have single mode or multiple modes. Using these “optical fiber channels”, the thin film optical devices can control light beams to travel with IC grade precision while controlling their properties.

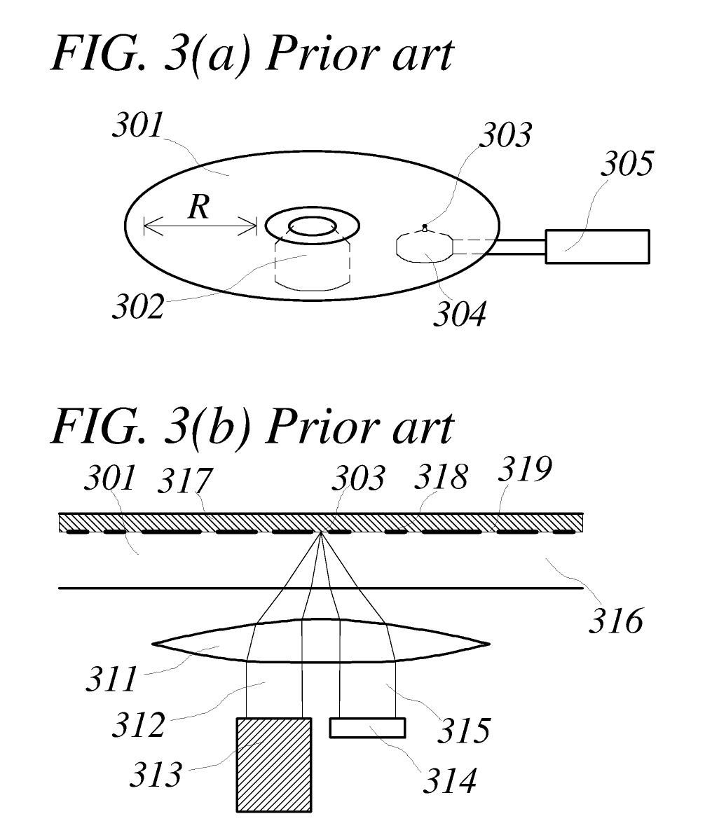

FIGS. 3(a,b) are simplified illustrations of the structure of a prior art compact disk (CD) driver. A motor (302) rotates a CD (301) against an optical device (304). The optical device (304) can detect the optical pattern at a small focal point (303) in order to read the data on the CD (301) as illustrated in FIG. 3(a). For a writable CD driver, the optical device (304) also can change the optical pattern at the focal point (303) to write data into the CD (301). The data points on the CD are distributed within a range (R). In order to read data points at different locations, a radial motor (305) is used to move the optical device (304) along radial direction of the CD. FIG. 3(b) is a magnified cross-section diagram showing more details near the focal point (303) in FIG. 3(a). The top layer (317) of the CD (301) is typically a reflective metal layer such as aluminum. The bottom layer 316) of the CD is a transparent protective layer typically made of polycarbonate plastic. One or more layers of thin films deposited between the two layers are patterned to represent data. For example, there are areas (319) that reflect incoming light beams (312) back to a light detector (314) like a mirror. These areas (319) represent binary data ‘1’. There are areas (318) that scatter or deflect light beams so that incoming light beams (312) won't be reflected back to the light detector (314). These areas (318) represent binary data ‘0’. The data representation convention can be reversed. A lens (311) focuses the light beam (312) emitted from a light source (313) onto a focal point (303) on the CD (301). If the light beam (312) is not scattered or deflected at the focal point (303), the reflected light beam (315) is directed to a light detector (314). The light source (313) is typically a solid state laser device controlled by integrated circuits. The light detector (314) is typically a light sensor supported by integrated circuits with timing control and data storage capability. The dimension of a data point (303) on current art CD is typically around 0.5 micrometers. Both the precision motor (305) and the optical device (304) must have sub-micrometer resolution in order to support current art CD drive operations. The lens (311) in FIG. 3(b) is a simplified symbolic representation of a complex precision lens system. Such lens system is typically expensive, and the resolution of the lens is limited by mechanical precision.

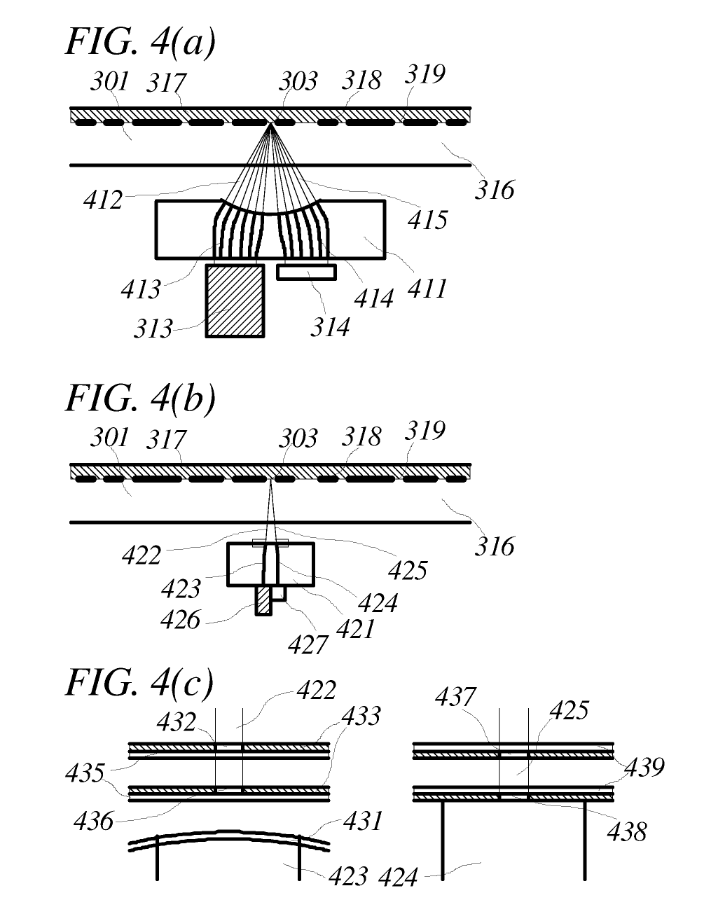

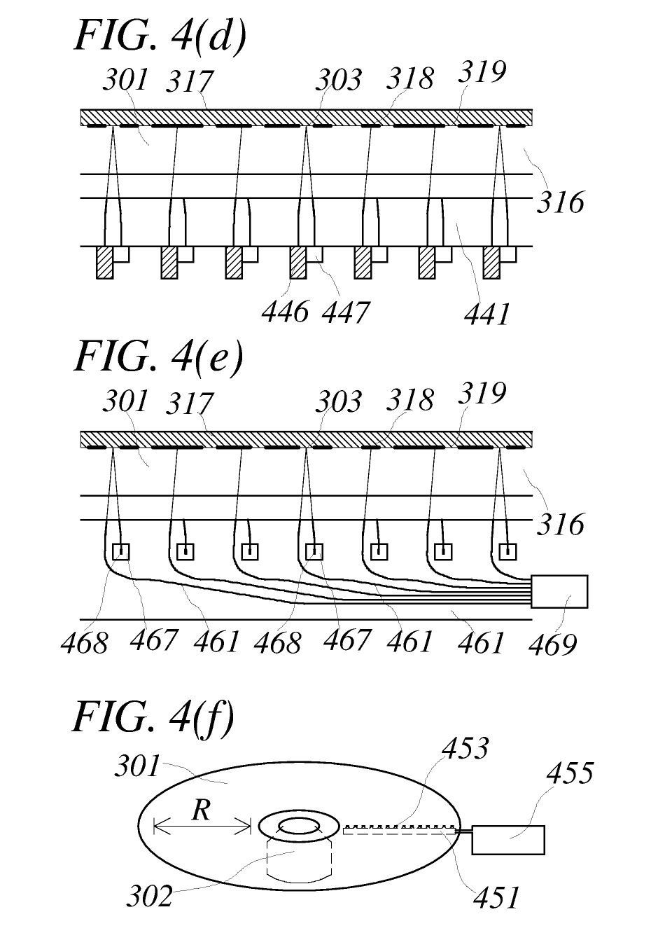

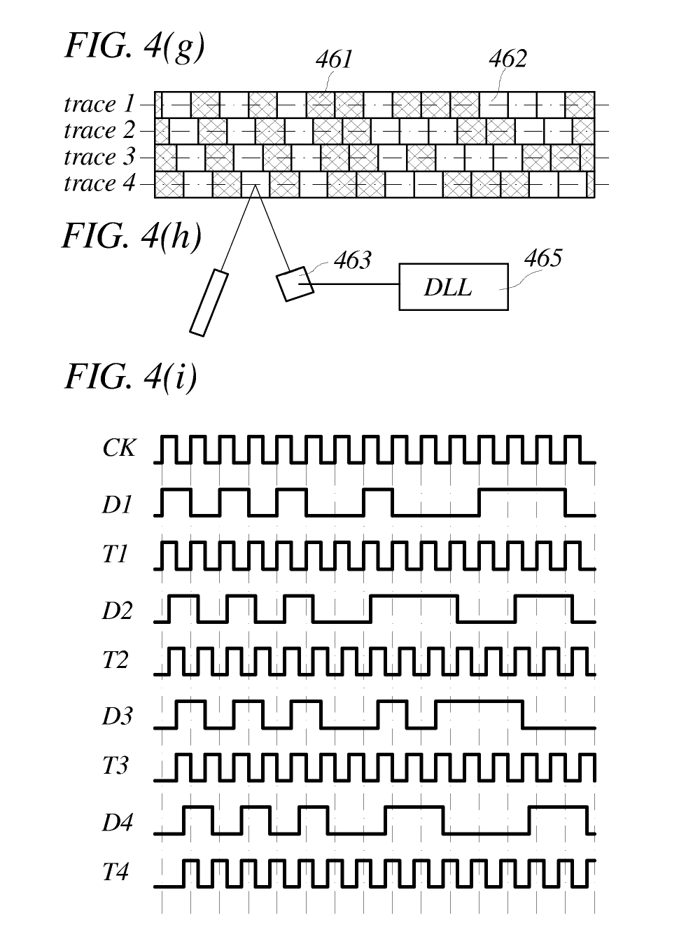

FIG. 4(a) shows the structure of an optical device that has nearly the same structure as the prior art device shown in FIG. 3(b); the difference is that the lens (311) in FIG. 3(b) is replace by an optical thin film device (411) of the present invention. In this example, the light beams (412) emitted from the light source (313) is guided by thin film optical fiber channels (413) pointing to the same focal point (303); the light beams (415) reflected by the CD are trapped and guided toward a light detector (314) by thin film optical fiber channels (414) that are also pointing to the same focal point (303), as illustrated by FIG. 4(a). The optical fiber channels (414) guiding reflected light beams (415) to the light detector (314) are mirror images of the optical fiber channels (412) guiding input light beams (412) emitted by the light source (313). Therefore, the optical paths between the light source (313) and the light detector (314) are matched if the data pattern at the focal point (303) behaves like a mirror. These optical fiber channels (412, 414) are manufactured with technologies described in FIGS. 2(a-j) to achieve IC grade precision. Therefore, this optical thin film device (411) is able to determine CD data patterns with IC grade precision.

It is well known that current art IC technologies can focus light beams to define complex patterns at 50 nm minimum dimensions with resolution measured in nm. By proper optical designs on the structures and composition of thin film devices, we can certainly approach similar accuracy. The thin film device uses the principle of total reflection to guide light beams, so that the light traveling paths are predictable with IC grade precision. The input and output channels for the thin film device in FIG. 4(a) are mirror images so that the resolution of the device is independent of environment changes such as temperature or humidity changes. They are able to achieve better resolution than prior art optical lenses. Achieving better resolution means we can use smaller dimensions to represent each bit of data in the CD. In this way, more data can be stored onto each CD, and the speed of CD drives is also improved. Better resolution also means we can improve power efficiency since less power is used to read or write the same amount of data. IC technologies have been optimized for mass production at excellent cost efficiency. Using thin film optical devices of the present invention to replace lenses also achieves better cost efficiency at mass production.

Those familiar with optical design certainly understand that FIG. 4(a) and our other figures are simplified for clarity. When the dimensions of optical components approach the scale of a wavelength of light, three dimensional interference effects become significant. The device (411) in FIG. 4(a) is actually a special three dimensional grating arranged in circular (or spherical) shape. We may need detailed designs to remove secondary focal points near the primary focal point (303) due to interference effects. Additional detailed designs, especially in the detailed geometry and index of refraction profiles, may be added to maximize data storage density. Sometimes the easiest ways to improve resolution is to shorten light wavelength or to increase index of refraction. These details are well known to those familiar with optical designs. To avoid using complex equations, we use over-simplified two-dimension diagrams in our examples. The actual optical device needs to consider three-dimension interference effects. The actual design comprises of detailed structures to compensate non-ideal effects for optimized results.

While specific embodiments of the invention have been illustrated and described herein, it is realized that other modifications and changes will occur to those skilled in the art. There are a wide variety of methods to design optical thin film devices using similar methods. For example, FIG. 4(b) shows another optical thin film device (421) of the present invention that serves the same function as the device in FIG. 4(a). In this example, the light beam (422) emitted from a light source (426) is guided by one thin film optical fiber channel (423) pointing to the focal point (303); the light (425) reflected by the CD is trapped and guided toward a light detector (427) by a thin film optical fiber channel (424) that also points to the focal point (303), as illustrated in FIG. 4(b). The optical fiber channel (424) guiding reflected light beams (425) to the light detector (427) is patterned as the mirror image of the optical fiber channels (423) guiding input light beams (422) emitted by the light source (426). These optical fiber channels (423, 424) are manufactured with technologies described in FIGS. 2(a-j) to achieve IC grade precision. Although only one channel is used as the light source and one channel is used as the light detector, we still can achieve excellent accuracy because only precisely aligned light beams would be able to reach the light detector. In addition, IC technologies allow optical designers to design detailed structures to improve resolution. For example, FIG. 4(c) shows magnified views of example designs for the tip of the optical fiber channels (423, 424) in FIG. 4(b); the area magnified by FIG. 4(c) is marked by dashed lines in FIG. 4(b). The tip of the output optical fiber channel (423) is shaped like a lens with an anti-reflection layer (431). The output light beam (422) is further narrowed down by two pinholes (432, 436). Each pinhole (432, 436) is surrounded by light reflecting or light absorbing materials (433) and anti-reflection layers (435) as illustrated in FIG. 4(c). Sometimes we may choose a combination of grating and pinholes to narrow down the output light beam (422). A typical choice for the light reflecting layer (433) at the pinhole is aluminum because that is the most common metal used by the IC industry. These pin holes are actually three dimensional designs with many details that are not shown in our simplified diagrams. In this example, the viewing angel for the input light beam (425) is also narrowed down by two pinholes (437, 438). The anti-reflection layers (439) for these input pin holes (437, 438) are on the outside surfaces near the tip of the input optical fiber channel (424). These pin holes (432, 436, 437, 438) maybe manufactured on the thin film device; they also can be manufacture separately. The structures in FIG. 4(c) are simplified for clarity. Designs for anti-reflection layers, thin film lens, pinholes, grating, and other features are well known to the art of optical design so we will not cover them in further detail. These detailed features can be manufactured with IC grade precision to optimize overall resolution of the system. There are wide varieties of methods to design these detailed optical features. The device in FIG. 4(a) and other figures also can have similar detailed designs. We will not cover those details for simplicity and clarity.

Since optical thin film devices (411, 421) use the principles of optical fiber to perform the function of lenses, we will call such a device an “optical fiber lens”. The optical lenses of the present invention can be very small in dimension. That means we can place a large number of them in a small space as illustrated in FIG. 4(d). In this example, the thin film optical device (441) in FIG. 4(d) comprises of a plurality of the optical fiber lens designed in the same way as the optical fiber lens in FIG. 4(c). Each optical fiber lens unit has its own light source (446) and light detector (447), allowing parallel operations to a plurality of data points (303, 318, 319) on the CD (301). Areas that remain transparent (319) reflect the emitted light beams back to detectors (447). For areas (318) that scatter light beams, the corresponding light detectors would not detect light signals.

FIG. 4(e) illustrates another multiple optical fiber lens design. In this example, the light detectors (467) are embedded in the substrate (461) of the optical thin film device. Optical fiber channels that collect reflected light are connected to the light detectors (467) through optical fiber via (468). Examples of the methods to manufacture optical fiber via have been illustrated in FIGS. 2(a-j). The control and timing circuits also can be embedded in the substrate (461 ) using the structures illustrated in FIG. 2(j). In FIG. 4(e), the optical fiber channels (463) for light sources are guided to the right hand side. In this way, we can place the light sources (469) at the right hand side, allowing additional design flexibility.

While specific embodiments of the invention have been illustrated and described herein, it is realized that other modifications and changes will occur to those skilled in the art. For example, we can embed both the light detectors and the light sources into the substrate. For another example, we can lead the optical fiber channels for both the light detectors and the light sources to the right hand or left hand side. For a read only CD driver, we can use a multiplexer to divide the light emitted from one or a small number of light sources to support a large number of optical fiber lenses. Further increase in number of optical fiber lens on a thin film device can be implemented by multiple layers of optical fiber channels using the structures illustrated in FIG. 2(i). For example, we can have optical fiber channels at one layer (102) support read operations, while the optical fiber channels at another layer (212) support write operations. Putting read and write channels on the same substrate can assure the best alignment. That also allows the possibility to read immediately before write. We also can use the multiple layer structures shown in FIG. 2(j) to have large number of channels supporting parallel operations. Multiple layers of optical fiber channels also can be used as redundancy. If one of the channels fails, we can use another channel to replace it.

FIG. 4(f) shows simplified structures of a CD driver equipped with a thin film optical device (451) of the present invention that has a plurality of optical fiber lenses. This device (451) can operate on multiple (number N) data points (453) in parallel. Using multiple optical fiber lenses provides many advantages. The read or write performance will be improved by N times. The radial motor (455) that controls radial motion of the optical device (451) only needs to control a distance R/N. These advantages further help to improve resolution.

When the optical thin film device (451) of the present invention improves resolution, one problem is that the mechanical components (301, 302, 455) of the CD driver may not be able to support the same accuracy. This problem can be solved by the self-aligned data pattern as illustrated by the example in FIG. 4(g).

FIG. 4(g) shows the symbolic view for self-aligned data pattern of the present invention. The shaded areas (462) represent binary data ‘0’ while the clear areas (461) represent binary data ‘1’. Each horizontal row (trace 1 to trace 4) represents one trace of data that can be detected by one light detector (463) during one rotation of the CD. The horizontal spacing of the data is determined by the clock cycle of data write operations. The vertical direction represents the direction controlled by the radial motor (455). The vertical spacing of the data between different traces is determined by the radial resolution of the system. Note that the data patterns between nearby traces are intentionally shifted during data write procedures. For this example, the data pattern in trace 1 is written earlier than the data pattern in trace 2 relative to the system clock (CK); the data pattern in trace 2 is written earlier than the data pattern in trace 3 relative to the system clock (CK); the data pattern in trace 3 is written earlier than the data pattern in trace 4 relative to the system clock (CK), and so on. Such data patterns provide a method to know whether the system is out of alignment by determining the phase of the data from the CD. In such ways, we no longer need to rely on the accuracy of the radial motor. To determine the phase, the data detected by light detector (463) is send to a timing circuit (465) such as a phase lock loop (PLL) or a delay lock loop (DLL) circuit as illustrated in FIG. 4(h). By well known circuit design methods, the timing circuit (465) can determine both the interval and the phase of the data transition accurately. Such timing circuits (465) require frequent data transitions that can be inserted by well known data transformation methods. FIG. 4(i) shows example timing wave forms for the outputs (D1-D4) of the light detector and the outputs (T1-T4) of the timing circuit (465) for each trace in FIG. 4(g) in comparison with the system clock (CK). The timing circuit outputs (T1-T4) provide self aligned data detection along each trace. The phase differences between data in different traces also provide self alignment along the radial direction. For example, when we are reading trace 2, if the phase of the detected data output is changed to the phase of trace 1, a feedback circuit notifies the radial motor (455) to move the location of the light senor back to trace 2. Similarly, if the phase of the detected data output is changed to the phase of trace 3, a feedback circuit notifies the radial motor (455) to move the location of the light senor back to trace 2. There are bursts of data loss during such misalignments but that is acceptable because all CD control circuits are equipped with interleaved error correction code (ECC) protocols that are able to recover the lost data.

While specific embodiments of the invention have been illustrated and described herein, it is realized that other modifications and changes will occur to those skilled in the art. For example, instead of phase shifts between different traces of data, we also can periodically insert location indicating signals into data patterns to indicate the horizontal and vertical locations on the CD detected by the light detectors. In such ways, the radial motor (455) can adjust the location if misalignment is detected. These self align data pattern of the present invention simplified mechanical control and further improve data storage density. The above discussions use CD drives as examples of the applications of the present invention. It should be obvious that similar devices of the present invention can support other pattern detecting/writing applications such as scanners, copiers, printers, optical mice (computer cursor control devices).

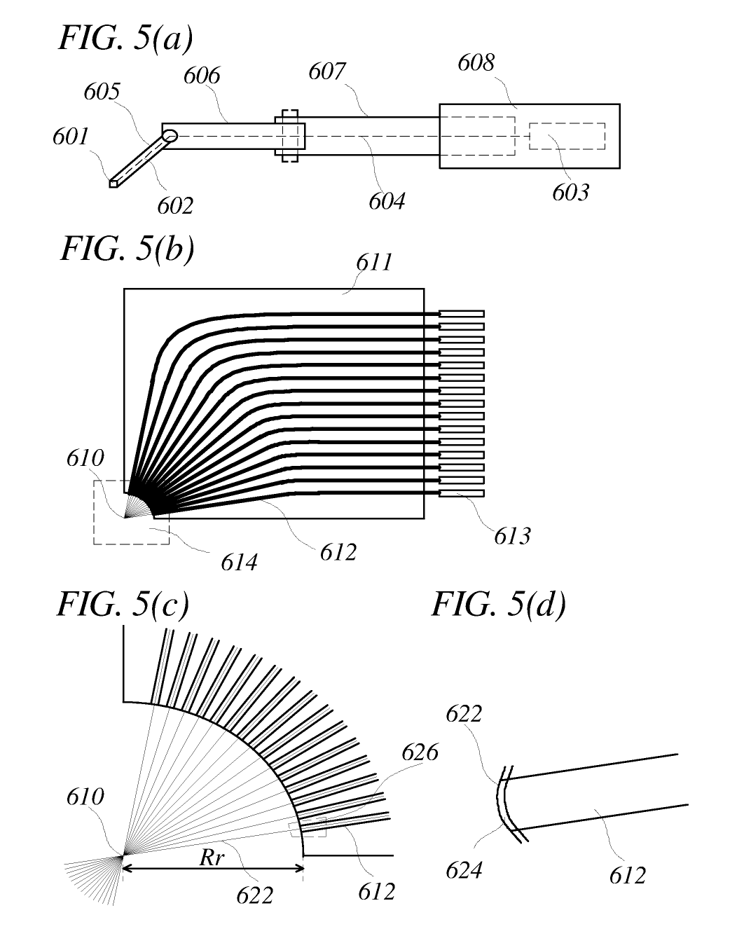

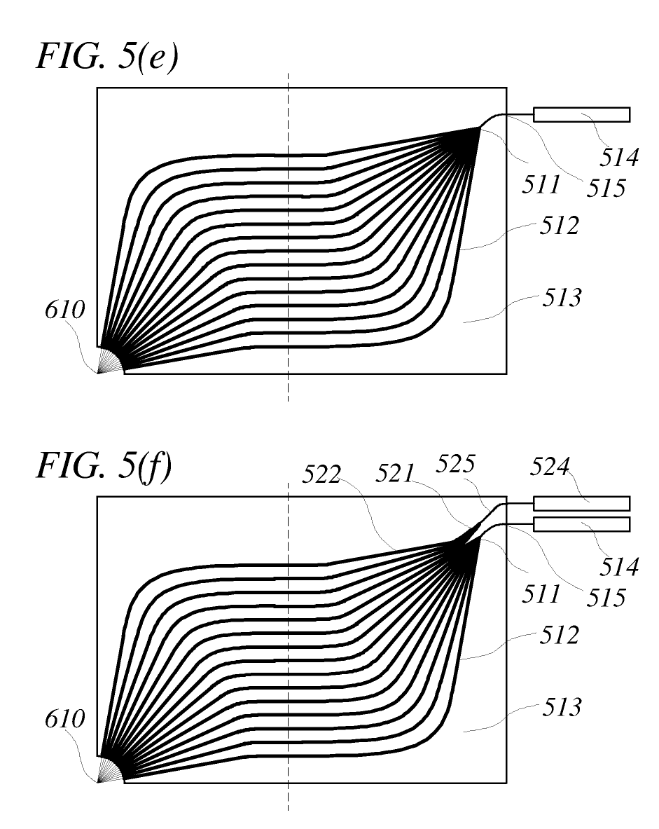

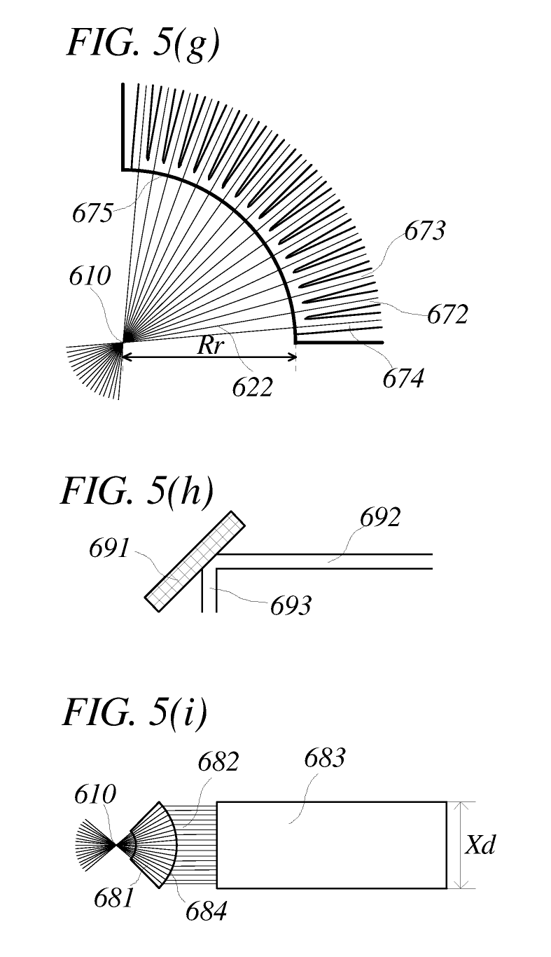

When we are able to focus strong light beams to a small focal point, the device can generate enough power to cut with extreme accuracy. FIG. 5(a) shows a robotic arm comprising of multiple arm sections (605-608). Each arm section can be precisely controlled to move relative to other arm sections. An optical fiber lens (601) of the present invention is installed at the tip of the robotic arm. The light inputs/outputs of this device (601) are provided by optical fiber(s) (602, 604) hidden inside the robotic arm. Optical-electrical circuits (603) use those optical fiber(s) (602, 604) to control cutting operations at the tip (601). Since the optical focal device (601) of the present invention can be as small as the tip of a needle, this robotic arm can be very small in dimension. This robotic arm can perform cutting or detecting applications using focused light energy with sub-micrometer accuracy. Improved resolution also means we can use less power—significantly reduce the chance to do damage at other locations. Doctors can use such precision arms to execute difficult surgery. Micro machines can be manufactured using such precision robotic arms.

FIG. 5(b) illustrates one example of an optical fiber lens (611) used at the tip (601) of the robotic arm in FIG. 5(a). This device comprises of many optical fiber channels (612) manufactured by methods illustrated in FIGS. 2(a-j). The light beams emitted from light sources (613) are guided by the optical fiber channels (612) toward the same focal point (610). Typical examples of light sources (613) are LASER devices or light emitting diodes (LED), but we certainly can use other types of light sources. The structures near the focal point are shown in further detail by the magnified diagram in FIG. 5(c). A plurality of optical fiber channels (612) is arranged evenly around a circle centered at the focal point (610); all the light beams (622) are guided toward the same focal point (610). Using IC patterning technologies, the geometric location of the focal point (610) can be defined with IC grade precision, while the radius of the circle (Rr) can be as small as IC grade length. However, due to the wave nature of light, we can never focus the light at an ideal geometric point. The device shown in FIG. 5(c) is actually a circular or spherical optical grating device. The light intensity would be spread out within a finite dimension (called effective dimension) even when we have perfect geometric precision. Considering the interference of light waves, there are spots with secondary intensity around the focal point (610). The light intensity at the secondary light points relative to that at the focal point (610) can be reduced when the number of light beams (622) increases. The effective dimension of the focal point is also related to the bandwidth, wavelength, and phase of the light beams (622). The light emitted from solid state light sources (613) can be controlled to have narrow bandwidth while the length and uniformity of optical fiber channels (612) can be controlled with precision using IC thin film manufacture technologies. In addition, we can use the precision of thin film patterning technologies to build precision optical components. For example, FIG. 5(d) illustrates the magnified structure (626) near the edge of the circle at the area marked by dashed lines in FIG. 5(c). We can build a small lens (622) with an anti-reflection layer (624) at the tip of the optical fiber channel (612) with IC grade precision. These and other high precision optical structures are made possible by the precision patterning capabilities of IC technologies.

The device in FIG. 5(b) uses multiple light sources (613). Such an arrangement allows us to have high energy density by combining the power of multiple light sources, but introduces greater difficulty in controlling the properties of the emitted light beams. FIG. 5(e) illustrates an example design that uses a single light source to achieve better control of light properties. The light emitted from a light source (514) is guided with a single optical fiber channel (515) to a thin film optical device (513). An optical multiplexer (511) divides the input light evenly into a plurality of optical fiber channels (512) as illustrated in FIG. 5(e). This multiplexer (511) is drawn in symbolic view. The actual structure is different. These optical fiber channels (512) guide the divided light beams to the same focal point (610) using structures similar to the previous example in FIG. 5(c). IC technologies will allow us to match the composition and the geometry of all the optical fiber channels (512) so that we can have excellent control over the properties (intensity, phase, polarity, mode, etc) of the light beams focused at the focal point (610). Better control of light properties means better control of the dimensions of the focal point. Please note that the locations where multiple optical fiber channels merge into one (or a few) optical fiber channel(s) are not considered “focal points”. By definition, light beams spread out before and after reaching a focal point but concentrate only on the focal point. For a multiplexer or de-multiplexer, after multiple light beams merge into one light beam, the merged light beam continues to have stronger energy density after the merge. Therefore, there is no “focal point”. In addition, focal points defined in the present invention are always outside of the thin film optical devices.

While specific embodiments of the invention have been illustrated and described herein, it is realized that other modifications and changes will occur to those skilled in the art. For example, FIG. 5(f) shows an example design that supports light detection at the focal point. In this example, part of the optical fiber channels (522) are merged by an optical de-multiplexer (521) into a single optical fiber channel (525) guided to a light detector (524). This de-multiplexer (521) is drawn in symbolic view while the actual structures can be different; we certainly can choose only one channel to avoid using de-multiplexer. Light reflected at the focal point (610) can be guided to the light detector (524) through these paths. In this way, we can monitor the activities at the focal point (610) using the light detector (524). We certainly can replace the light detector (524) with a light source to combine the outputs of two different light sources at the focal point (610). Similar structure can be implemented by multiple layers of optical fiber channels using the structures illustrated in FIG. 2(i). For example, we can have optical fiber channels at one layer (102) connect to light source(s), while the optical fiber channels at another layer (212) connect to light detector(s). In these ways, we can control and detect the light density at the focal points. Since optical devices are bidirectional devices. An optical device that can focus light on a focal point also can detect light emitted from the focal point. We certainly can use optical switches to use the same optical thin film devices of the present invention for both output and input purposes.

In the above examples, different optical fiber channels are separated from each other. For communication devices, separating different optical fiber channels are necessary to avoid cross talks between signals carried in different channels. For applications of the present invention, we have the options to allow cross talks between different channels and merge different optical fiber channels. FIG. 5(g) shows an example when the optical fiber channels (672-674) are merged with each other before reaching the edge (675) of the device. All the channels (672-674) still point to the same focal point (610), but we allow the light carried in those channels to merge. For example, one of the optical fiber channels (672) is merged with nearby two channels (673, 674) before reaching the edge (675). In this way, we have more freedom in making the dimension (Rr) of the tip smaller to achieve better accuracy. The light coming out of the edge (675) also can be more uniform. For example, we can design the edge (675) of the device to form a portion of three dimensional sphere surface focusing on the same focal point (610) to achieve optimum resolution. Such designs are certainly applicable for other applications such as the CD read/write devices.

Optical fibers use the principle of total reflection to guide traveling directions of light beams. To meet the requirements of total reflection, optical fibers can not change directions rapidly. The curvature of an optical fiber is limited by the requirement for total reflection. Such limitations in curvatures often increase the dimensions of optical fiber devices. To achieve small dimensions, the optical fiber channels described in the above examples may use methods other than total reflection to guide traveling light beams. Such design details were not described in the above figures. FIGS. 5(h, i) provide simplified examples when reflection or fraction are used to change light traveling directions more rapidly. FIG. 5(h) shows a reflection mirror (691) is placed in the path of an optical fiber channel (692) to change the light traveling direction into another optical fiber channel (693) of different direction. This reflection mirror (691) can be metal (such as aluminum) or any material that has different index of reflection (such as air cavity). Reflection is useful to provide rapid direction changes but reflection can cause complex three dimensional interferences with changes in light intensity and light properties; the actual design of the reflection mirror (691) may require detailed compensation structures that are not shown in our simplified discussions; when the dimensions of the mirror (691) and the optical fiber channels (692, 693) are defined with IC grade accuracy, the light quality after reflection is more controllable. FIG. 5(i) shows another example when the change in direction is provided by refraction. In this example, an optical device (681) of the present invention is focusing light on a focal point (610) on the left hand side while the index of refraction profile at its right hand side (684) is shaped like a lens. The structures of this device near the focal point (610) can be similar to previous examples in FIGS. 5(c, g). Due to refraction, the light beams (682) from the light path (683) on the right hand side are first banded toward the focal point by the lens shaped edge (648) before guided by the optical device (681) with IC grade precision toward the focal point (610). The optical device (681) in this example can have optical fiber channels as illustrated in previous examples; it also can be a thin film lens shaped with IC grade precision. The light path (683) can be a light source (e.g. a LASER), one or more optical fiber(s), one or more thin film optical fiber channels, a optical wave guide, or other types of devices. We certainly can use devices of the present invention in combination with prior art optical lens to achieve better precision. Using the design in FIG. 5(i), the dimension (Xd) can be very small (for example, a few micrometers) because it is not limited by curvature constraints.

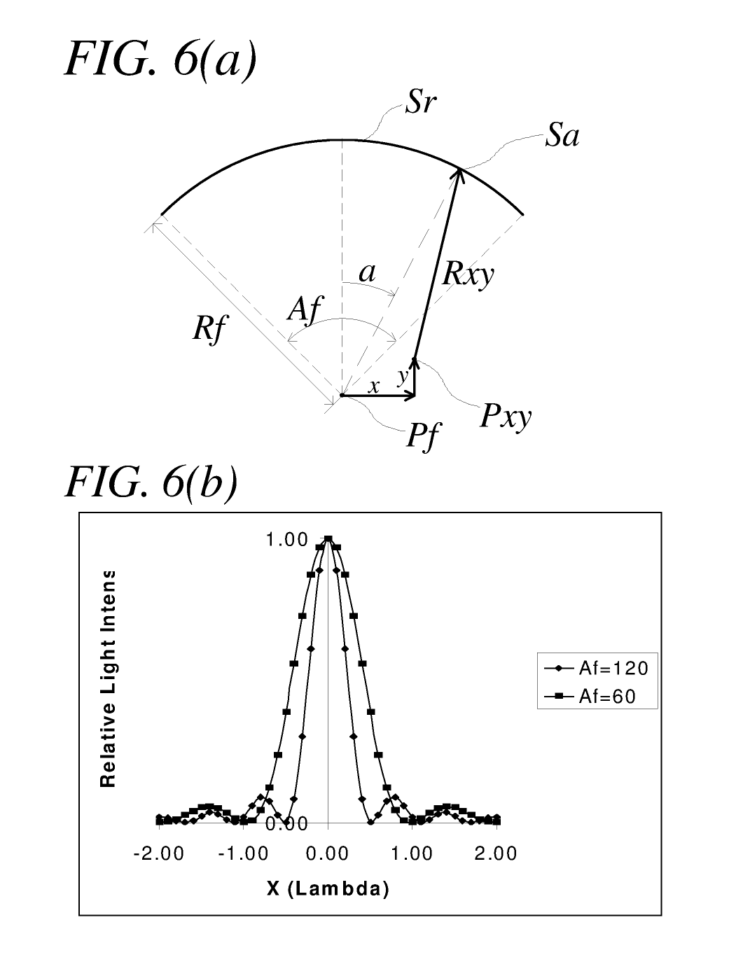

For simplicity, we have not discussed the effects of interference in the above examples. It is well known that the effects of optical interference can be calculated by computer simulations with accuracy. For example, the device in FIG. 5(g) can be considered as a circular shaped light source as shown in FIG. 6(a). In this simplified example, a circular arc light source (Sr) is focused on a focal point (Pf); the distance (Rf) from the focal point (Pf) to any point (Sa) on the circular light source (Sr) are the same so that the light on the focal point (Pf) is always in phase if all the light at different points on the light source (Sr) are in phase. The radius of this arc (Sr) is Rf, while its aperture angle is Af. FIG. 6(a) shows a point (Pxy) at a location (x, y) away from the focal point (Pf), where y axis is a line passing through the focal point and the center of the light source (Sr) as illustrated in FIG. 6(a), x axis is a line passing through the focal point (Pf) vertical to y axis, and the focal point (Pf) is the original of this coordinate system. FIG. 6(a) also shows a point (Sa) on the light source (Sr) that is at an angle (a) from the y axis. Based on the geometry shown in FIG. 6(a), the distance (Rxy) from the point (Pxy) to the point (Sa) is
Rxy=Rf*[(sin(a)−(x/Rf))²+(cos(a)−(y/Rf))²]^{1/2} EQ(1).

The phase difference (dp(a)) between the light coming from Sa to the focal point Pf and the light coming from Sa to Pxy is
dp(a)=(2*Pi/Lambda)*(Rxy−Rf) EQ(2),

where Lambda is light wave length, and Pi=3.14159265 is the angular value equal to 180 degrees. The amplitude of light Axy at point Pxy is the combination of all the light emitted from all points (Sa) on the light source (Sr), including interference effects, as
Axy=INT_{-Af/2}^{Af/2}A(a)da=INT_{-Af/2}^{Af/2}[I(a)e^{i dp(a)}]da EQ(3),

where INT_{-Af/2}^{Af/2} A(a)da represents an angular integration for amplitude A(a) from light source point Sa, and A(a)=[I(a) e^{i dp(a)}] considering both amplitude I(a) and phase e^{i dp(a)}.

Using EQ(1-3), we are able to calculate the light intensity at any point (Pxy). Assuming light source intensity I(a) is a constant, the author calculated the intensity along x axis for two different aperture angles (Af=120 degrees and Af=60 degrees) as shown in FIG. 6(b). We can see that the light intensity is a sharp peak at the focal point (Pf). The peak width is around the dimension of light wavelength (Lambda). The wider the aperture angle, the sharper the peak. With careful designs, typically we can achieve peak width around half wavelength.

The above examples in FIGS. 6(a, b) are simplified examples. The actual geometry in FIG. 5(g) is a three dimensional interference structure. It is well known that computer simulations are able to determine light intensity at different locations accurately for very complex geometries so that there is no need to cover the interference effects in more details. In general, the shorter the wavelength, the higher the index of refraction, the wider the aperture angle (Af), the sharper the focal point. For the case of CD read/write, it is desirable to increase the index of fraction for the transparent cover layer (316). With proper designs, optical devices of the present invention can focus light within a fraction of the wavelength.

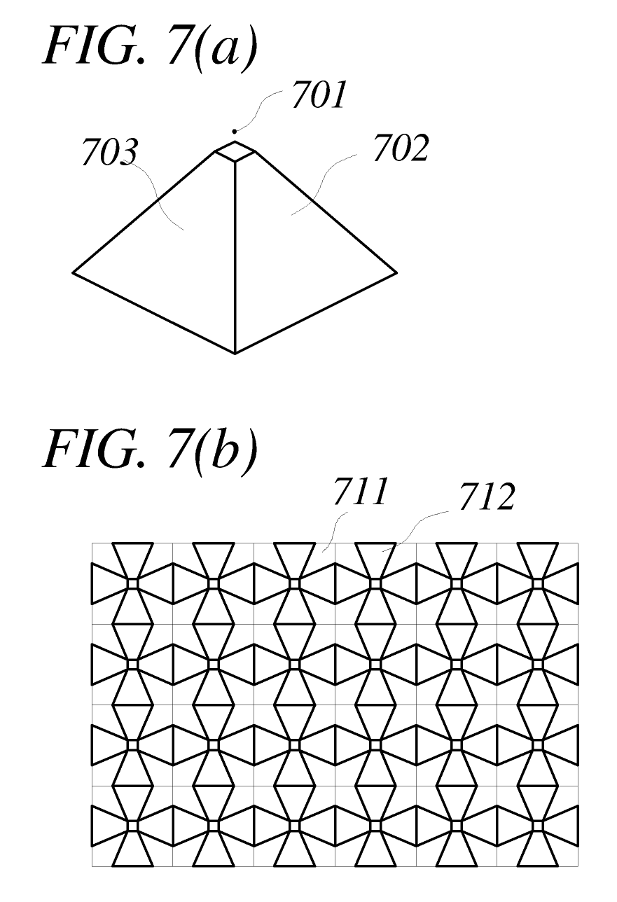

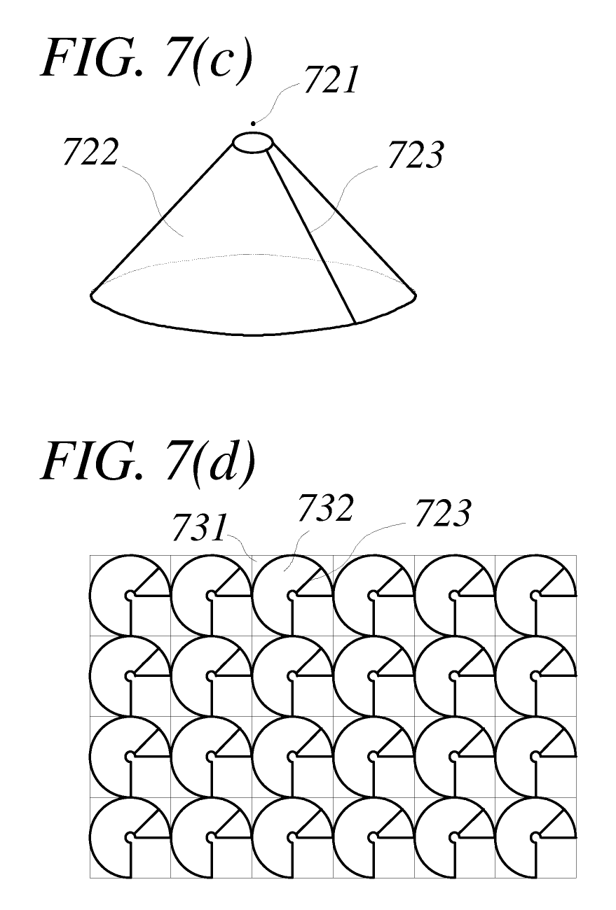

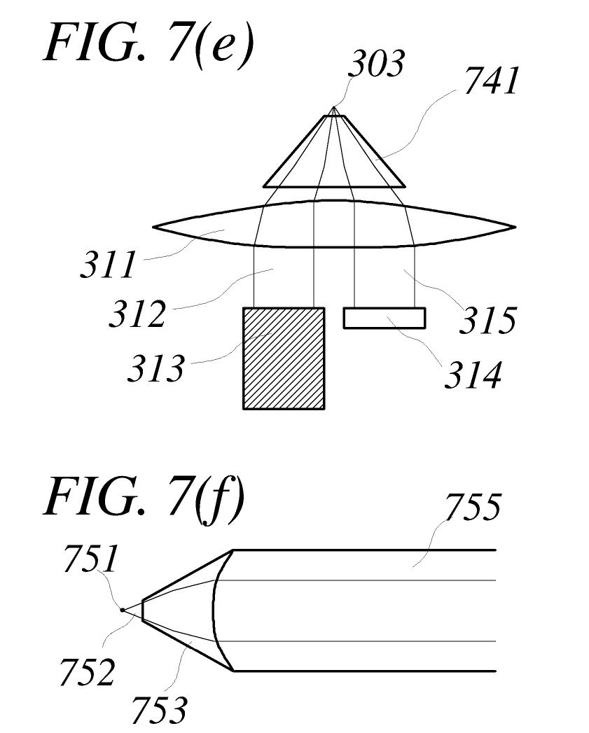

For thin film devices, we have more design freedom on the surface while we have less design freedom on the vertical dimension; it is therefore more difficult to control the dimension of focal point vertical to the thin film surface. One solution of this limitation is to use three dimensional wave guide devices as illustrated in FIGS. 7(a-f). FIG. 7(a) shows an example when 4 optical thin film devices (702, 703) of the present invention are arranged as a pyramid while focusing on the same focal point (701). These devices (702, 703) may have optical fiber channels (not shown) following similar design principles shown in previous examples. This pyramid structure helps to reduce the effective size of the focal point caused by interference effects. The obvious question is how to align those 4 devices to the same focal point with accuracy. One way to assure accurate alignment is to define the dimensions of the devices (702, 703) with IC grade accuracy. FIG. 7(b) shows an example on the method to define the dimensions of the pyramid in FIG. 7(b). In this example, a plurality of repeating units (711) are patterned on top of a flat substrate using IC patterning procedures. Each repeating unit (711) comprises 4 optical thin film devices (712). Each device (712) corresponds to one surface of the pyramid in FIG. 7(a). Each optical thin film device (712) can have optical fiber channels or other optical components using methods described previously. Since all the dimensions are determined with IC grade resolution, we will be able to build the pyramid to focus on the same focal point with accuracy.

FIG. 7(c) shows another example when an optical device (722) of the present invention is arranged as a cone shaped structure, while all the light paths on the cone point to the same focal point (721). This device (722) may have optical fiber channels (723) or it may be a cone coated with thin film wave guide pointing to the focal point (721). We can manufacture this cone mechanically then coat light guiding thin films on the cone. One way to assure accurate alignment is to define the dimensions with IC grade accuracy using patterns shown in FIG. 7(d). In this example, a plurality of repeating units (731) are patterned on top of a substrate using IC patterning procedures. Each repeating unit (731) comprises a partial circle device (732). The materials used for this example are flexible materials (for example, plastic) so that we can wrap the partial circle device (732) into the cone in FIG. 7(c). Each partial circle device (732) can have optical fiber channels or other optical components using methods described previously. Since all the dimensions are determined with IC grade resolution, we will be able to build the cone with accuracy. It is even possible to build multiple cones of different dimension overlapping each other while all the cones all point to the same focal point (721).

FIG. 6(e) illustrates one example for the applications of the present invention. This example shows the same structures used for the prior art CD read/write optical device (304) shown in FIG. 3(b) except that an optical device of the present invention (741) is placed in the light path to improve light focusing accuracy. The cone shaped device shown in FIG. 7(c) is applicable for this example. Arranging in this way, we will be able to build CD read/write devices using nearly identical manufacture procedures while improving CD data density and read/write performance.

FIG. 6(f) shows another example for the application of the present invention. In this example, a device of the present invention (753) is placed on the tip of a conventional optical fiber (755). The light beam (752) in the optical fiber is guided to a focal point (751) with IC grade accuracy provided by the device of the present invention (753).

While specific embodiments of the invention have been illustrated and described herein, it is realized that other modifications and changes will occur to those skilled in the art. A point is the building unit for geometry. If we are able to focus light at a single point, we certainly can focus light at multiple points. Combining multiple points, we can focus high density light beams into any shape to form a focal image with accuracy. Upon disclosure of the present invention, light focusing devices with focus images of different shapes will be apparent to those familiar with the art. Reversing the optical fiber channels, we will be able to detect the light intensity at precision focal points. In our examples, the focused light beams are used to cut materials near the focal points. In general, we can use the focused light beam to cause chemical reactions or physical transformations with precision location control. Such chemical reactions or physical transformations can be destructive or constructive.

While specific embodiments of the invention have been illustrated and described herein, it is realized that other modifications and changes will occur to those skilled in the art. It is to be understood that the appended claims are intended to cover modifications and changes as fall within the true spirit and scope of the invention.

What is claimed is:

1. A thin film optical device comprising: (a) substrate, (b) thin film layers manufactured on top of said substrate, and (c) patterned areas of different index of refraction in said thin film layers, where the patterns of said areas of different index of refraction are defined by lithograph procedures, wherein said patterned areas of different index of refraction provide light paths pointing to one focal point outside of said thin film optical device.

2. The thin film optical device in claim 1 is used to determine data represented by optical properties near said focal point.

3. The thin film optical device in claim 2 is used to support compact disk (CD) read operations.

4. The thin film optical device in claim 1 is used to write data by changing optical properties near said focal point.

5. The thin film optical device in claim 4 is used to support compact disk (CD) read operations.

6. The thin film optical device in claim 1 is used to cause chemical reactions or physical transformations near said focal point by focused light energy.

7. The thin film optical device in claim 1 is arranged in a three dimensional structure for providing light paths pointing to the same focal point.

8. The three dimensional structure in claim 7 is a pyramid.

9. The three dimensional structure in claim 7 is a cone.

10. The three dimensional structure in claim 9 comprises a plurality of cones pointing to the same focal point.

11. A method for manufacturing thin film optical device, said method comprising the steps of: (a) forming thin film layers on top of a substrate, (b) patterning areas of different index of refraction in said thin film layers using lithograph procedures, wherein said areas of different index of refraction provide light paths pointing to the same focal point outside of said thin film optical device.

12. The thin film optical device in claim 11 is used to determine data represented by optical properties near said focal point.

13. The thin film optical device in claim 12 is used to support compact disk (CD) read operations.

14. The thin film optical device in claim 11 is used to write data by changing optical properties near said focal point.

15. The thin film optical device in claim 14 is used to support compact disk (CD) read operations.

16. The thin film optical device in claim 11 is used to cause chemical reactions or physical transformations near said focal point by focused light energy.

17. The thin film optical device in claim 11 is arranged in a three dimensional structure for providing light paths pointing to the same focal point.

18. The three dimensional structure in claim 17 is a pyramid.

19. The three dimensional structure in claim 17 is a cone.

20. The three dimensional structure in claim 19 comprises a plurality of cones pointing to the same focal point.
